(19) United States
(12) Patent Application Publication
(10) Pub. No.: US 2026/0027749 A1
(43) Pub. Date: Jan. 29, 2026

(54) SUPPORT MEMBER WITH IMPROVED VENTILATION

(71) Applicant: Stafier International B.V., ZEVENAAR (NL)

(72) Inventor: Ruben Theodoor BEIJER, ZEVENAAR (NL)

(21) Appl. No.: 19/170,140

(22) Filed: Apr. 4, 2025

(30) Foreign Application Priority Data
Apr. 8, 2024 (NL) 2037414
Apr. 8, 2024 (NL) 2037415

(51) Int. Cl. B28B 11/24; F26B 25/18

(52) U.S. Cl. CPC B28B 11/248; F26B 25/18; F26B 2210/02

(57) ABSTRACT

The present invention relates to a support structure configured for drying clay forms while being supported thereon. The support structure comprises a rectangular support surface provided with perforations, having two short and two long perimeter edges, and four support walls extending perpendicularly from the perimeter edges in the same direction. Each support wall is provided at its edge facing away from the support surface with a support wall flange extending parallel to and beneath the support surface. Optionally, the support structure includes a U-shaped reinforcement profile extending parallel to the long support walls between the support walls extending from the short perimeter edges. The ends of each leg of the U-shaped reinforcement profile are provided with securing elements extending perpendicularly to the legs, by which the reinforcement profile is attached to the support surface.

### RELATED APPLICATIONS

The present application claims priority from and the benefit of Netherlands Patent Application No. 2037414, filed Apr. 8, 2024 and Netherlands Patent Application No. 2037415, filed Apr. 8, 2024, the disclosure of each of which is hereby incorporated herein by reference in full.

### FIELD OF THE INVENTION

The present invention relates to a support member on which clay forms, particularly for bricks, such as masonry bricks or roof tiles, are placed for drying during use.

### BACKGROUND OF THE INVENTION

Two types of support members for drying clay forms are distinguished, namely drying plates and drying slats. Drying plates are used on drying racks that are placed in a drying chamber, where the drying plates are typically positioned against each other or with a narrow gap on a rack. Often, the products to be dried are placed with their longitudinal axis perpendicular to the longitudinal axis of the drying plates. Therefore, the drying plates are relatively wide and are also provided with support walls at their short sides. To prevent deflection of the support surface, the support walls extend downward perpendicularly from the support surface. Furthermore, with a perpendicular orientation of the support walls, adjacent drying plates can be positioned against or compactly next to each other.

When using drying slats, the clay products to be dried are typically placed on two slats spaced apart, or in a specific case, the width of a drying slat corresponds to the width of a clay product to be dried, and the bricks are placed in alignment on a drying slat. The drying slats are positioned at a mutual distance on a conveyor belt, which transports them through a drying oven perpendicular to the longitudinal direction of the slats and the bricks.

### SUMMARY OF THE INVENTION

More specifically, according to a first aspect, the present invention relates to a support member configured to dry clay forms while being supported on a first side of the support member before they are fired into, for example, bricks or roof tiles. The support member comprises a perforated rectangular support surface with two short and two long perimeter edges. If the support surface is square, the perimeter edges designated herein as long and short have the same length. The support member further comprises four support walls extending from the perimeter edges away from the first side, each of which is provided at an end facing away from the support surface with a support wall flange extending parallel to and beneath the support surface, thus directed towards each other.

Such support members are well known. Clay forms are placed on the support member, and multiple support members are placed in a drying chamber for an extended period to gradually dry the clay forms before firing. The perforations in the support surface contribute to the ventilation of the clay forms lying on the support surface for drying.

European patent application EP 0 676 605 A1 discloses a carrier for freshly formed ceramic bodies to be dried, such as hollow blocks, and a support arrangement for freshly formed bodies. The carrier for unfired bodies consists of a reinforced carrier profile made of steel plate in the form of an inverted U, wherein the base of the U and the legs of the U are held, and the amount of openings in the surface is between 35% and 65%.

European patent application EP 1 625 922 A1 discloses a support element for bricks that are dried while being supported by the support element. The support element comprises a plate with downward-extending plate edges. A reinforcement profile extends between the side walls, which reinforcement profile is connected to the bottom of the plate at spaced-apart fastening points, wherein a spacer is provided between two fastening points to maintain the reinforcement profile at a distance from the plate between the two fastening points.

The drying of clay forms requires a significant amount of time. The present invention, therefore, aims to provide a support member for clay forms according to the preamble, wherein moisture exits the clay forms more quickly or can at least exit more efficiently during drying thereon, allowing the clay forms to be dried faster. According to the present invention, this objective is achieved by providing at least one of the support walls with ventilation holes. The ventilation holes improve the airflow beneath the support member, allowing moisture to exit the clay forms more quickly or at least more efficiently during drying and wherein moisture can then be absorbed into the air beneath the support surface, and humid air below the support surface can be more effectively replaced with relatively dry air. Thus, the objective of the present invention is achieved.

Providing holes in a (side) wall may initially seem like an obvious solution; however, upon closer consideration, this is not the case. Drying plates as support members on which clay forms for bricks or roof tiles are placed for drying before firing have existed for a long time. A drying plate with a length of 300 to 4000 mm and a width of 80 to 1500 mm is fully loaded with clay products that are placed at just enough distance from each other to minimally hinder the drying process. This results in a substantial load on the drying plate with moist clay. The support surface must not or only minimally bend to prevent the clay forms from deforming during drying due to resting on a non-flat surface. Over the years, drying plates have been improved, for example, by adding reinforcement profiles or folding the end of an extended support wall flange. When a support wall is provided with ventilation holes, also referred to in this document as aeration holes to improve ventilation beneath the support surface, the respective support wall must be made of thicker (sheet) material, or other measures must be taken to provide the support wall, which is weakened by the ventilation holes, with the required strength.

It is preferred that two opposing support walls are provided with ventilation holes. This promotes the flow of (fresh) air beneath the support surface. When the two long support walls adjacent to the long perimeter edges are provided with ventilation holes, the ventilation capacity is improved.

The best result for ventilation with fresh air is achieved when all support walls are provided with ventilation holes.

Also and more specifically, according to a second aspect, the invention relates to a support member configured to dry clay forms while being supported on a first side of the support member. The support member comprises a perforated rectangular support surface with two short and two long perimeter edges. If the support surface is square, the perimeter edges designated herein as long and short have the same length. The support member further comprises four support walls extending from the perimeter edges away from the first side, each of which is provided at an end facing away from the support surface with a support wall flange extending parallel to and beneath the support surface. The support member also includes a U-shaped reinforcement profile extending parallel to the long support walls between the support walls extending from the short perimeter edges, wherein at each end of the legs of the U-shape is provided with fastening elements extending away from each other parallel to the support surface, by which the reinforcement profile is secured to the support surface.

The drying of clay forms requires a significant amount of time. The present invention therefore aims to provide a support member for clay forms, as described in the preamble, which enables more efficient drying of the clay forms.

According to the present invention, this objective is achieved by providing the reinforcement profile with ventilation holes on at least one side facing a support wall of the U-shape. The ventilation holes improve the airflow between the underside of the support member and the reinforcement profile, allowing moisture to exit the clay forms more quickly during drying. Thus, the objective of the present invention is achieved.

Since a reinforcement profile, like a support wall discussed in relation to the first aspect of the invention, serves to prevent deflection of the support surface, similar considerations apply. Measures such as forming the reinforcement profile from a thicker (sheet) material must be considered to ensure that the reinforcement profile retains sufficient strength despite the presence of ventilation holes.

It is preferred that the reinforcement profile is provided with ventilation holes on both sides facing a support wall and/or in the connecting portion of the U-profile. The more surface area of the reinforcement profile is replaced by ventilation openings (holes), the greater the ventilation capacity.

If holes on both sides facing a support wall are at least substantially aligned with each other, virtual flow channels are effectively formed through the support member, reducing airflow resistance compared to a non-aligned orientation of the ventilation holes. If, in addition, any ventilation holes in the connecting portion of the U-shape are also aligned, the ventilation capacity is further enhanced.

The effect of the invention is further amplified when the first and second aspects of the invention are combined within the support member. That is, when at least one of the support walls, as well as the reinforcement profile on at least one side facing a support wall of the U-shape, is provided with ventilation holes. Preferably, all support walls and all three sides of the reinforcement profile are provided with ventilation holes.

Preferably, the holes in the opposing support walls, and, if applicable according to the second aspect of the invention, in the legs of the U-shaped reinforcement profile, are distributed over at least substantially the entire length of the support wall or walls, respectively the reinforcement profile. This ensures that a large portion of the potentially available ventilation or aeration capacity is utilized.

For an optimal balance between the strength and material usage of the support member on the one hand, and ventilation capacity on the other, the ratio of material to continuous ventilation openings in a perpendicular projection of a side of the reinforcement profile or a support wall is 75:25, more preferably 60:40 or 20:80, and even more preferably 50:50.

If, in an embodiment according to the second aspect of the invention, the fastening elements of the reinforcement profile are configured as tabs spaced apart from each other in the longitudinal direction, fewer perforations are covered by the connecting element than in a reinforcement profile according to the prior art, where the connecting element is formed as a continuous flange. This also contributes to improved ventilation at the underside of the clay forms resting on the support surface.

In a preferred embodiment, the support member comprises a U-shaped reinforcement profile extending parallel to the long support walls between the support walls that extend from the short perimeter edges in the longitudinal direction. At one end of each of the U-legs, the reinforcement profile is provided with fastening elements that extend parallel to the support surface and away from each other, securing the reinforcement profile to the support surface.

The latter measure may, however, also be applied independently of the first and second aspects of the invention in a support member configured for drying clay forms while being supported on a first side of the support member during support. The support member comprises a rectangular support surface with perforations, two short and two long perimeter edges, and four support walls extending away from the first side along the perimeter edges. Each support wall is provided at its end, facing away from the support surface, with a support wall flange extending parallel to and underneath the support surface. Additionally, the support member comprises a U-shaped reinforcement profile extending parallel to the long support walls between the support walls that extend from the short perimeter edges in the longitudinal direction. At the end of each U-leg, the reinforcement profile is provided with fastening elements that extend parallel to the support surface and away from each other, securing the reinforcement profile to a second side of the support surface opposite the first side, wherein the fastening elements are configured as tabs spaced apart from each other in the longitudinal direction.

Support members with a U-shaped reinforcement profile but without ventilation holes in the U-legs are well known. Clay forms are placed on the support member, and multiple support members are positioned for an extended period in a drying chamber to gradually dry the clay forms before firing. The perforations in the support surface contribute to ventilating the clay forms resting on it by facilitating drying from below. The conventional reinforcement profile has two continuous flanges along its entire length as fastening elements, which are spot-welded to the underside of the support surface.

Drying clay forms requires a significant amount of time. Therefore, the present invention aims to provide a support member for clay forms, as described in the preamble, which allows moisture to escape more quickly from the clay forms during drying, and with which clay forms can be dried more quickly, thereby accelerating the drying process. This is achieved by implementing the previously mentioned measure, in which the fastening elements are configured as tabs spaced apart in the longitudinal direction. By replacing the continuous flanges of a reinforcement rib according to the prior art with the tabs spaced apart in the longitudinal direction according to the invention, the majority of the essential perforations for drying, which are covered by the flanges in the prior art, remain unobstructed.

Since the clay forms retain moisture the longest in the center, and the reinforcement profile typically extends across the center of the support member, the perforations between the tabs, which remain open in the support member according to the invention but are blocked by the flange in the prior art, are located in a critical area for the drying process. Consequently, they contribute to a faster clay form drying process compared to a support member of the prior art, thereby achieving the intended objective of the invention.

Preferably, in said longitudinal direction, the tabs have a tab length, and the space, that is, the center-to-center distance between two adjacent tabs on the same side of the reinforcement profile is at least three times, preferably at least five times, and more preferably at least seven times the tab length. The greater the spacing (for a given tab length), the fewer perforations are obstructed by the tabs of the reinforcement profile, and the faster the drying process. The choice of spacing is a trade-off between the strength of the connection between the reinforcement profile and the support surface and optimal ventilation.

The tab length is preferably within the range of 7 to 20 mm, more preferably 9 to 15 mm, and even more preferably 11 to 13 mm. Here too, a balance is struck between the strength of the connection between the reinforcement profile and the support surface and optimal ventilation. The dimensions and possibly the shape of the perforations, or the material between the perforations in the support surface, may also be considered.

The tabs may be arranged on opposite sides of the fastening element at the same height on the reinforcement profile, providing a symmetrical attachment.

Alternatively, the tabs on opposite sides of the fastening element may be staggered relative to each other, preferably by half the center-to-center distance of two adjacent tabs on the same side. This arrangement results in a more gradual distribution of covered perforations, preventing the formation of concentrated blocked areas on both sides of the reinforcement profile.

In a preferred embodiment, the reinforcement profile is attached to the support surface by spot welding the tabs. Spot welding is suitable for creating such local connections, but other joining techniques may also be considered.

Preferably, the reinforcement profile, together with the second side of the support surface, defines a trapezoidal shape. A trapezoidal shape can be easily formed from a sheet by bending. This applies to the reinforcement profile as well, where the tabs may also be included in the forming process to create a localized omega-shaped profile.

It is preferred that the angle between a leg of the reinforcement profile and the support surface is within the range of 75 to 105 degrees, more preferably between 85 and 95 degrees, and even more preferably exactly 90 degrees. Most preferably, the legs converge from the support surface toward the connecting part of the U-shape or are positioned perpendicularly to the support surface.

When the support wall flanges and the connecting part of the U-shaped reinforcement profile, particularly their undersides, extend in the same plane, the support member, and especially the support surface, forms a stable base for placement on a flat surface.

For proper support of a support member loaded with moist clay forms, the support walls extend at an angle of 75 to 105 degrees, preferably 85 to 95 degrees, relative to the support surface. A perpendicular orientation of the support walls allows two or more support members to be positioned compactly against each other.

If the perforations in the support surface are preferably circular and include at least an upper edge with a downward-rounded perimeter of the surrounding material, this provides a smoother transition than in support surfaces of prior-art support members for clay forms. This effect does not necessarily require a perfectly circular perforation-an oval shape is also conceivable.

This last-mentioned measure can also be implemented independently of the present invention in a support member configured for drying clay forms while being supported on it, with a support member comprising a rectangular support surface with perforations, two short and two long perimeter edges, and four support walls extending perpendicularly from the perimeter edges in the same direction as the support surface, each support wall having a support wall flange at its end, extending parallel to and beneath the support surface, wherein preferably, the perforations in the support surface are circular and at least comprise an upper edge with a downward-rounded perimeter of the surrounding material.

It is preferred that the support member has a length greater than 300 mm, preferably greater than 400 mm, and further preferably greater than 500 mm, and less than 3500 mm, preferably less than 3000 mm.

Additionally, or alternatively, it preferably has a width greater than 80 mm, preferably greater than 150 mm, further preferably greater than 200 mm or 250 mm, and less than 1500 mm, preferably less than 1250 mm and further preferably less than 1000 mm.

### BRIEF DESCRIPTION OF THE FIGURES

The present invention will now be further explained with reference to preferred embodiments of the invention, or details thereof, as illustrated in the accompanying drawings, in which:

FIG. 1a shows a perspective top view of a first embodiment of a drying plate according to the present invention;

FIG. 1b shows a perspective exploded top view of the drying plate from Fig. la;

FIG. 2 shows a bottom view of the drying plate from FIG. 1;

FIG. 3 shows a side view of the drying plate from FIG. 1;

FIG. 4 shows a front view of the drying plate from FIG. 1;

FIG. 5 shows a vertical cross-sectional view of a perforation in a support plate according to the present invention.

### DETAILED DESCRIPTION

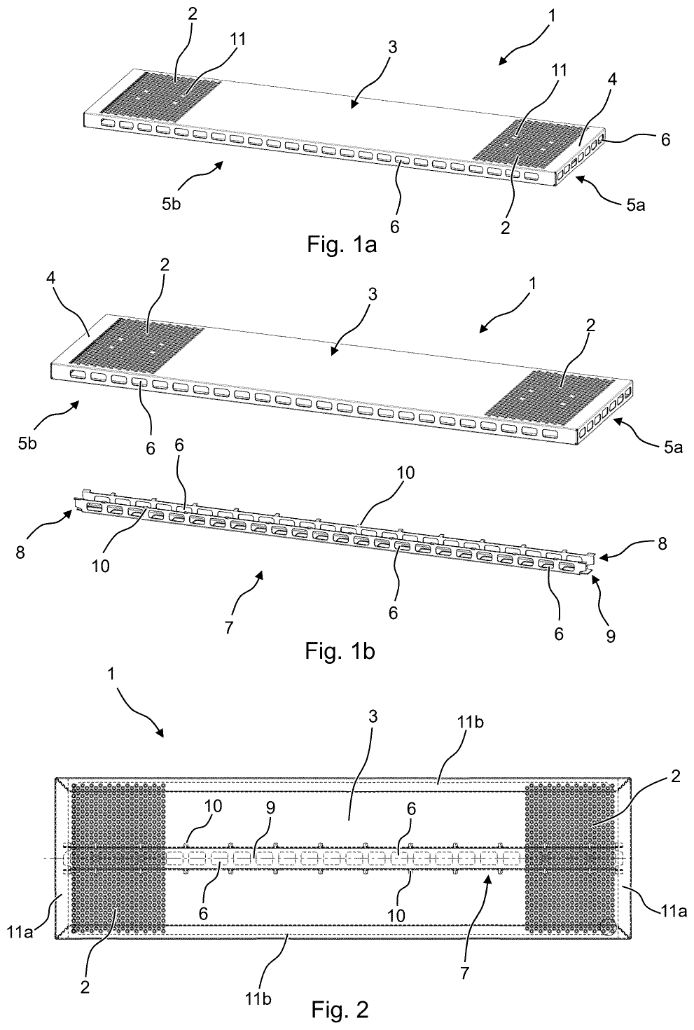

Referring to FIG. 1, a perspective top view of a drying plate 1 is shown as an embodiment of a support member according to the present invention. Typically, a drying plate for drying clay forms before firing has a length ranging from 900 to 4000 mm and a width from 80 to 1500 mm, with this example. 1 measuring 2000×150 mm. The (brick) tiles or roof tiles placed on such a drying plate 1 for drying can have a length varying from 50 to 1500 mm and a width varying from 50 to 600 mm. The drying plate 1 is manufactured through bending operations from aluminum sheet metal with punched perforations 2. Perforations in drying plates for clay forms are usually round, with a diameter ranging from 3 to 8 mm, in this example 5 mm. The drying plate features a top panel 3 as a support surface, whose first side, the top side, is visible in Fig. la. For clarity, only a portion of the perforations 2 is shown in the figures. In practice, the entire top panel 3 is equipped with perforations 2, while the perimeter edge 4 of the top panel 3 may optionally be left free of perforations.

The drying plate has two short side walls 5a and two long side walls 5b serving as support walls, of which only one of each is visible in FIG. 1a. Both the short 5a and long 5b side walls of the drying plate 1 are provided with a series of ventilation holes 6. The reinforcement profile is not visible in FIG. 1a as it is located behind the top panel 3.

FIG. 1b presents a perspective exploded top view of the drying plate 1 from FIG. 1a, revealing the reinforcement profile 7. The reinforcement profile 7 has a generally U-shaped vertical cross-section with two side panels 8 corresponding to the legs of the U and a connecting panel 9 extending between the legs. At the ends of the legs opposite the connecting panel 9, outward-extending fastening tabs 10 are provided. In the assembled state of the drying plate 1, the fastening tabs 10 are spot-welded to the underside of the top panel 3. The spot weld locations 11 are depicted as white areas between the perforations 2 in Fig. la.

Both the side panels 8 and the connecting panel 9 of the reinforcement profile 7 are equipped with ventilation holes 6, similar to the ventilation holes 6 in the side walls 5a, 5b.

FIG. 2 shows a bottom view of the drying plate 1 from FIG. 1, revealing the second side, or bottom side, of the top panel 3, where the perforations 2 are also visible from the other side (and are, of course, distributed across the entire drying plate 1). Additionally, on the underside of the drying plate 1, two support wall flanges 11a, configured as short strips, and two support wall flanges 11b, configured as long strips, are visible. In a normal orientation these flanges extend beneath and parallel to the top panel 3, extend toward each other, as shown in FIG. 1. Between the short strips 11a, the reinforcement profile extends centrally and parallel to the long strips 11b.

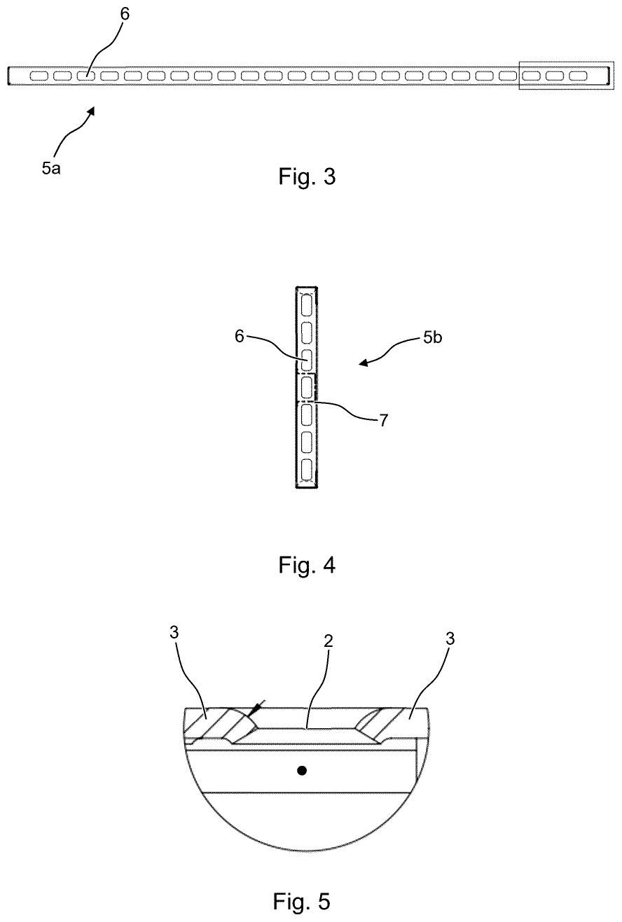

For completeness, FIGS. 3 and 4 provide a side view and a front view, respectively, of the drying plate 1, where the ventilation holes 6 are even more clearly visible than in FIGS. 1a and 1b.

FIG. 5 illustrates one of the many (identical) perforations 2 in the top panel 3 of the drying plate 1 according to the present invention. Unlike a simple perforation created by drilling or punching, the material surrounding the perforation 2 does not extend flatly within the main plane of the top panel 3. In this embodiment, the material near the perforation 2 bends downward. This effect is achieved by applying an additional impact with a conical punch to the edge of the perforations after they are initially punched. The curved transition of the material from the top panel 3 towards the perforations 2 enhances the drying efficiency of the clay forms resting on the top panel.

When clay forms are placed on the drying plate, they will dry faster compared to a clay form placed on a conventional drying plate. This is because the ventilation holes 6 in the side walls 5a and 5b allow air to flow more freely beneath the perforated top panel 3 than the solid side walls of a conventional drying plate. In particular, ventilation is significantly improved in the middle of the plate, leading to a much faster drying process than in conventional drying plates. The ventilation holes 6 in the side panels 8 and the connecting panel 9 allow air to reach the perforations 2 located above the reinforcement profile 7, which, in conventional reinforcement profiles, are more or less sealed off from the surrounding air. Additionally, the fastening tabs 10 cover significantly fewer perforations 2 in the middle of the top panel 3 compared to continuous fastening flanges running along the entire length of the reinforcement profile. Thus, the reinforcement profile 7 enhances airflow beneath its longitudinal axis, where clay forms typically dry the slowest, while the ventilation holes 6 in the side walls 5a, 5b, and in the side panels 8 and connecting panel 9 further contribute to better ventilation beneath the top panel 3 with relatively dry air.

The present invention has been described with reference to a single exemplary embodiment of a drying plate as illustrated in the accompanying figures and explained in the above description. However, it should be clear that many variations, whether obvious to a skilled person or not, fall within the scope of protection defined in the following claims. In particular, dimensions can vary by 10 or 20 cm, and the drying plate may also be square as a specific form of a rectangle.

### REFERENCE NUMERALS LIST

1 drying plate
2 perforations
3 top panel
4 perimeter edge of 3
5a short side wall
5b long side wall
6 ventilation hole
7 reinforcement profile
8 side panel of 7
9 connecting panel of 7

10 fastening tab
11a short strip
11b long strip

1. A support structure configured for drying clay forms while being supported thereon, the support structure comprising a rectangular support surface provided with perforations, having two short and two long perimeter edges, and four support walls extending in the same direction and perpendicularly from the perimeter edges of the support surface, each support wall being provided at its edge facing away from the support surface with a support wall flange extending parallel to and beneath the support surface, wherein at least one of the support walls is provided with ventilation holes.

2. The support structure according to claim 1, wherein two opposing support walls are provided with ventilation holes.

3. The support structure according to claim 2, wherein all support walls are provided with ventilation holes.

4. A support structure configured for drying clay forms while being supported thereon, comprising a rectangular support surface provided with perforations, having two short and two long perimeter edges, and four support walls extending in the same direction and perpendicularly from the perimeter edges of the support surface, each support wall being provided at its edge facing away from the support surface with a support wall flange extending parallel to and beneath the support surface, and a U-shaped reinforcement profile extending parallel to the long support walls between the support walls extending from the short perimeter edges, which U-shaped reinforcement profile at the ends of each leg of the U-shape is provided with securing elements extending perpendicularly to the legs, by which the reinforcement profile is attached to the support surface, and wherein the reinforcement profile is provided with ventilation holes on at least one of its sides facing a support wall.

5. The support structure according to claim 4, wherein the reinforcement profile is provided with ventilation holes at the base of the U-shape, on both sides facing a support wall, and/or on the connecting section of the U-profile.

6. (canceled)

7. The support structure according to claim 4, wherein the holes in the legs of the U-shaped reinforcement profile are distributed over at least substantially the entire length of the support walls or reinforcement profile, respectively, and/or wherein a perpendicular projection of a support wall or side includes a material-to-hole ratio of no more than 75:25.

8. The support structure according to claim 4, wherein the securing elements are configured as tabs spaced apart from one another in the longitudinal direction.

9. The support structure according to claim 8, wherein the tabs, in said longitudinal direction, have a tab length, and wherein the spacing between two adjacent tabs on the same side of the reinforcement profile is at least three, times the tab length, and/or wherein the tab length ranges from 7 to 20 mm.

10. The support structure according to claim 8, wherein the tabs on opposite sides of the securing element are arranged opposite each other, or wherein the tabs on opposite sides of the securing element are offset relative to each other, and/or wherein the reinforcement profile is attached to the support surface by spot welding the tabs.

11. The support structure according to claim 4, wherein the reinforcement profile defines a trapezoidal shape with the second side of the support surface, with the angle between a leg of the reinforcement profile and the support surface is in the range from 75 to 105 degrees.

12. The support structure according to claim 4, wherein the support wall flanges and the connecting section of the U-shaped reinforcement profile extend in the same plane.

13. The support structure according to claim 4, wherein the support walls extend at an angle of 75 to 105 degrees relative to the support surface.

14. The support structure according to claim 4, wherein the perforations in the support surface are circular and include at least an upper side with a downward-rounded perimeter edge.

15. The support structure according to claim 2, wherein at least the two long support walls adjacent to the long perimeter edges are provided with ventilation holes.

16. The support structure according to claim 1, wherein the holes on both sides facing a support wall are at least substantially aligned with each other.

17. The support structure according to claim 1, wherein the holes in opposing support walls are distributed over at least substantially the entire length of the support walls or reinforcement profile, respectively, and/or wherein a perpendicular projection of a support wall or side includes a material-to-hole ratio of no more than 75:25.

18. The support structure according to claim 1, wherein the support walls extend at an angle of 75 to 105 degrees relative to the support surface.

19. The support structure according to claim 1, wherein the perforations in the support surface are circular and include at least an upper side with a downward-rounded perimeter edge.
